(19) United States
(12) Patent Application Publication
(10) Pub. No.: US 2021/0086154 A1
(43) Pub. Date: Mar. 25, 2021

(54) DRY POLYMER FRACKING SYSTEM

(71) Applicant: Noles Intellectual Properties, LLC, Washington, OK (US)

(72) Inventor: Jerry W. NOLES, Blanchard, OK (US)

(73) Assignee: Noles Intellectual Properties, LLC, Washington, OK (US)

(21) Appl. No.: 16/630,809

(22) PCT Filed: Jul. 13, 2018
(86) PCT No.: PCT/US2018/042121

§ 371 Date: Jan. 13, 2020

Related U.S. Application Data
(60) Provisional application No. 62/532,125, filed on Jul. 13, 2017.
(60) Provisional application No. 62/611,398, filed on Dec. 28, 2017.

(51) Int. Cl. B01F 15/00; E21B 43/26; B01F 3/12; B01F 15/02

(52) U.S. Cl. CPC B01F 15/00292; E21B 43/2607; B01F 3/12; B01F 15/0229; B02C 21/02; B01F 15/00149; B01F 15/00142; B01F 15/00311; B01F 2215/0081; B01F 15/0251

(57) ABSTRACT

A system for introducing bulk dry material into a fluid system includes a vessel, wherein the vessel is closed; an outlet wherein the outlet is located on a bottom of the vessel; a valve controlling the outlet; corner locking pins located on the outside of the vessel; a scale; and a controller. The system may include a conveyor; a hopper; a motor; and a shearing device.

### CROSS-REFERENCE TO RELATED APPLICATIONS

This application is the National Stage of International Application No. PCT/US2018/042121, filed Jul. 13, 2018; which application claims the benefit of and priority to U.S. Provisional Patent Application No. 62/611,398 titled “Dry Polymer Frac System” and filed Dec. 28, 2017 and to U.S. Provisional Patent Application No. 62/532,125 titled “Dry Polymer Fracking System” and filed Jul. 13, 2017, the disclosures of which are incorporated in their entirety by this reference for all purposes.

### BACKGROUND

In recent history, hydraulic fracking has enabled the United States to become a world leader in energy production. This technology conventionally deploys the use of fluids pumped at a high rate into a subterranean reservoir to apply sufficient force to separate or fracture the rock, thereby allowing any oil and gas to flow into a well bore disposed within the rock. The fluid typically is water, but it can be a water-based solution (e.g., brine), oil-based, synthetic oil-based, or other fluid. For ease of reference, in this application the liquid or fluid medium of fracturing or frac water will be referred to as water, but this is understood to include water-based solutions (which may comprise other liquid, solid, and/or gaseous components) and other fluid-based solutions (which has a constituent base other than water, such as oil or synthetic oil or other fluid or gas, even if water is present, or other liquids, solids, and/or gaseous components are present).

This technology typically uses millions of gallons of water to carry proppant, such as sand, into any fractures in the rock generated by the fracking process. The proppant is designed, ideally, to prevent the fractures from closing once the injection of water has stopped and the pressure has dissipated, which would otherwise permit the rock to try to regain its original state and close the fractures.

To aid in the injection of the fracturing or frac water and the transportation of the proppant, certain chemicals typically are introduced into the water that may be designed to reduce pump pressure, facilitate the disposition of the proppant into the fractures, and other desirable qualities.

The chemicals added to the frac water typically have been in a liquid form due to the ease of storing and introducing a liquid chemical into the water system. However, in many cases, the manufacturing of these chemicals in liquid form may add to the volume of the chemicals as would otherwise be the case if the chemical were in dry form. Further, the liquid form of these chemicals may be diluted in order to make it easier to pump; but this in turn may increase the volume of the liquid chemical drastically, making them yet more difficult and expensive to store and to transport. This dilution may also make the chemicals less functional or economical by increasing the required dosage ratios to achieve a desire effect. Thus, using liquid chemicals may increase the costs of the material, increase the costs of storing and transporting these chemicals, and other disadvantages.

For these and other reasons, some companies have tried to design and build dry chemical introduction systems that add dry chemicals to the frac water. These chemicals may include polymers, potassium chloride, surfactants, oxidizing breakers and other chemicals that may be available in a dry bulk concentration. The dry chemicals allow may be stored and transported in bags on pallets or super sacks. The chemicals in these bags or sacks are in turn introduce to the frac water. However, this method often requires manual handling of the bags or sacks to move and introduce the chemical into the frac system. More specifically, large batch tanks typically are needed to stir and mix the chemicals into the fluid system. Smaller systems to add dry chemicals typically are open to the atmosphere and may pose a health risk from the inhalation of air born particles during the mixing and introduction of the chemicals into batch or mixing tanks. Further, these open systems typically are problematic in adverse weather conditions, such as high humidity, wind, rain or snow.

Therefore, there is a need for a cost effective, efficient, and safe system and method to introduce these dry chemicals into the fluid system.

### BRIEF SUMMARY

In an embodiment, a system includes a cost effective, efficient, and safe way to introduce bulk dry material into a fluid system. In one embodiment, the system comprises: a vessel, wherein the vessel may be closed; an outlet, wherein the outlet may be located on the bottom of the vessel; a valve controlling the outlet; corner locking pins located on the outside of the vessel; a scale; and a controller.

In an embodiment, a system includes a cost effective, efficient, and safe way to introduce bulk dry material into a fluid system. In one embodiment, the system comprises a vessel, wherein the vessel may be closed; a conveyor; a hopper; a motor; and one of a colloid mill and a high-speed mixer.

In another embodiment, a system for introducing material into a fluid at a well site includes a closed vessel that includes an inlet and an outlet for receiving and dispensing the material, respectively. A valve is configured to control a flow of the material out of the outlet. A shearing device is configured to receive the material from the closed vessel. A main pipe is configured to transmit a main stream of a fluid and a diversion pipe is configured to transmit a diverted stream of fluid.

Optionally, the diversion pipe is configured to transmit the diverted stream of fluid from the main pipe and return the diverted stream of fluid to the main pipe.

Optionally, the shearing device dispenses the material received from the closed vessel into one of the main stream of fluid and the diverted stream of fluid. The shearing device may be one of a colloid mill and a high-speed mixer.

The system may include a conveyor configured to transmit the material from the outlet of the vessel to the shearing device. The conveyor device may be one of a conveyor belt or an auger.

The material may be at least one of a dry chemical and a polymer and the fluid may include water.

Optionally, the vessel may include at least one of a scraper or a rod.

The system may also include a processor configured to implement computer executable instructions, a first input interface may be in communication with the processor and configured to receive an indication of at least one of a flow rate of the material out of a vessel in which the material is stored, a flow rate of a main stream of fluid, a flow rate of a diverted stream of fluid, a concentration of the material in the main stream of fluid, and a concentration of the material in the diverted stream of fluid. A first output interface may be in communication with the processor and configured to output a control signal for controlling an actuation mechanism coupled to an outlet of the vessel. A computer memory may be in communication with the processor and storing computer executable instructions, that when implemented by the processor cause the processor to perform functions comprising:

calculate the control signal for controlling the actuation mechanism to adjust the flow rate of the material out of the outlet of the vessel based on at least one of a time, the concentration of the material in the main stream of fluid, the concentration of the material in the diverted stream of fluid, the flow rate of the material, and a parameter of the main stream of fluid;

dispense the material into one of the main stream of fluid and the diverted stream of fluid; and,

measure and send an indication to the processor of at least one of the flow rate of the material out of a vessel in which the material is stored, the flow rate of a main stream of fluid, the flow rate of a diverted stream of fluid, the concentration of the material in the main stream of fluid, and the concentration of the material in the diverted stream of fluid.

In another embodiment, a control system for an apparatus that dispenses a material into a fluid includes include a processor configured to implement computer executable instructions, a first input interface may be in communication with the processor and configured to receive an indication of at least one of a flow rate of the material out of a vessel in which the material is stored, a flow rate of a main stream of fluid, a flow rate of a diverted stream of fluid, a concentration of the material in the main stream of fluid, and a concentration of the material in the diverted stream of fluid. A first output interface may be in communication with the processor and configured to output a control signal for controlling an actuation mechanism coupled to an outlet of the vessel. A computer memory may be in communication with the processor and storing computer executable instructions, that when implemented by the processor cause the processor to perform functions comprising:

calculate the control signal for controlling the actuation mechanism to adjust the flow rate of the material out of the outlet of the vessel based on at least one of a time, the concentration of the material in the main stream of fluid, the concentration of the material in the diverted stream of fluid, the flow rate of the material, and a parameter of the main stream of fluid;

dispense the material into one of the main stream of fluid and the diverted stream of fluid; and,

measure and send an indication to the processor of at least one of the flow rate of the material out of a vessel in which the material is stored, the flow rate of a main stream of fluid, the flow rate of a diverted stream of fluid, the concentration of the material in the main stream of fluid, and the concentration of the material in the diverted stream of fluid.

The functions may further comprise:

calculate a new control signal for controlling the actuation mechanism to adjust the flow rate of the material out of the outlet of the vessel based on at least one of the concentration of the material in the main stream of fluid, the concentration of the material in the diverted stream of fluid, the flow rate of the material, and the parameter of the main stream of fluid;

operate the actuation mechanism to adjust the flow rate of the material;

operate a shearing device that receives the material; and

shear the material prior to or concurrently with dispensing the material into one of the main stream of fluid and the diverted stream of fluid.

Optionally, the processor is located remotely from the vessel and communicates wirelessly with the actuation mechanism.

The parameter of the main stream of fluid may be at least one of a viscosity and a density of the main stream of fluid.

Optionally, the actuation mechanism is manually adjustable.

The control system may further include a conveyor coupled to the processor, and the function may further comprise transferring the material dispensed from the vessel via the conveyor to the shearing device.

The control system may further include a scale coupled to the conveyor, wherein the scale is in communication with the processor and wherein the function may further comprise receiving at the processor a signal indicative of a weight of the material as measured by the scale.

The control system optionally includes a motor coupled to the shearing device, the motor being in communication with the processor and/or a motor coupled to the conveyor, the motor being in communication with the processor.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are and will be understood by those of ordinary skill in the art to encompass obvious improvements and modifications thereto.

Additional advantages of the present invention will become readily apparent from the following discussion, particularly when taken together with the accompanying drawings.

### DESCRIPTION OF THE DRAWINGS

To further clarify the above and other advantages and features of the one or more present inventions, reference to specific embodiments thereof are illustrated in the appended drawings. The drawings depict only typical embodiments and are therefore not to be considered limiting. One or more embodiments will be described and explained with additional specificity and detail through the use of the accompanying drawings in which:

FIG. 1 illustrates an embodiment of a vessel for receiving, storing, and dispensing a material;

FIG. 2 is a cross-section A-A taken through the vessel of FIG. 1;

FIG. 3 illustrates a plurality of vessels of FIG. 1 in a stacked configuration;

FIG. 4 illustrates the vessel of FIG. 1 loaded on a trailer;

FIG. 5 illustrates a plurality of vessels of FIG. 1 loaded on another trailer;

FIG. 6 illustrates a conveyer in the stowed position on a trailer;

FIG. 7 illustrates a conveyor in the stowed position on another trailer;

FIG. 8 illustrates the conveyor of FIG. 7 in the operable position;

FIG. 9 illustrates a representative schematic of the material processing system and the associated control system;

FIG. 10 illustrates a colloidal mill;

FIG. 11 illustrates a high-speed mixer; and,

FIG. 12 illustrates a representative schematic of a shearing device and an associated fluid system.

The drawings are not necessarily to scale.

### DETAILED DESCRIPTION

In embodiments, the system provides sealed containers for bulk dry chemicals to be loaded in at a manufacturing or a central facility. The chemicals may then be stored in these containers at a warehouse or transported to an application or frac site. These containers may then be used to introduce the dry chemical into the frac or frack fluid system.

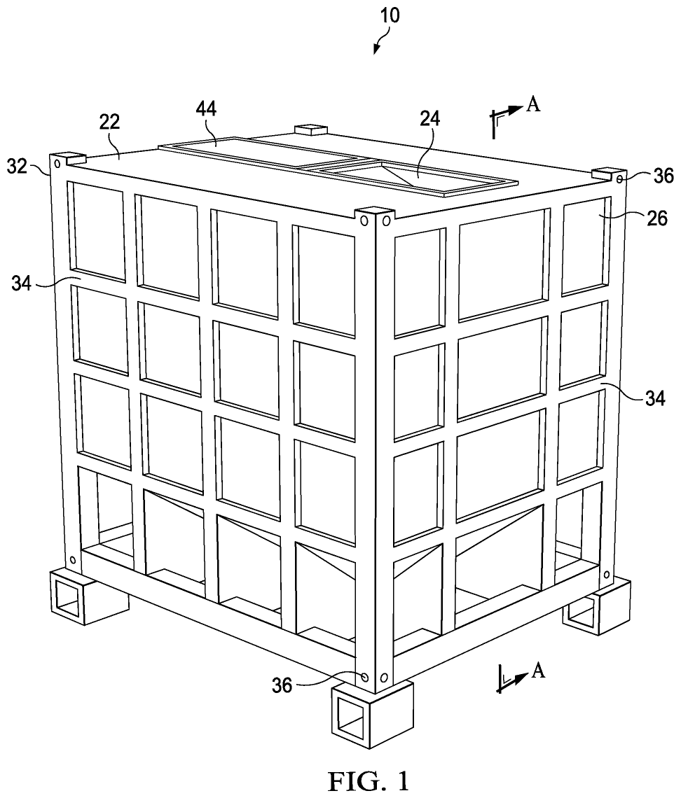

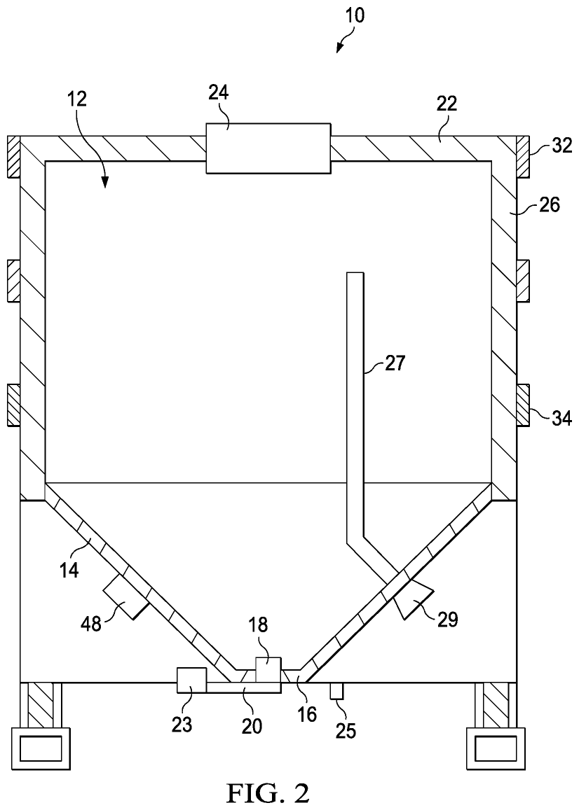

The present disclosure uses one or more stackable vessels 10, as illustrated in FIGS. 1 to 5, with an interior volume 12 defined in part by one or more sloped sides 14 and/or bottom 16. The sloped slides 14 may intersect at one or more corners or edges of the sloped slides or be defined by a conical or frusto-conical shape with sufficient slope to allow the chemical to freely flow from an outlet that may be positioned into the bottom center of the vessel or to an offset side outlet 18 on the bottom. This design allows the dry material to flow under the influence of gravity into this reduced diameter or this smaller dimensional outlet 18.

The outlet 18 may be sealed with slide gates and/or valves 20 that keep the dry material contained in the vessel 10. The valves and/or slide gates 20 can be used to control the release of dry chemicals from the vessel 10 or the emptying of the vessel 10 at the application or well site. This configuration may be a sealed vessel 10 and may be of any configuration including but not limited to, square, round or rectangular configuration. The top 22 of the vessel 10 may include an inlet 24, such as an opening, doors, or other apparatus that can be selectively opened and closed and allows for the introduction of the dry chemicals into the vessel 10. The inlet 24 typically is in the top 22 of the vessel, but it may be placed on a side 26 or elsewhere on the vessel 10. The inlet 24 may be flanged or sealed to prevent moisture from entering into the vessel 10.

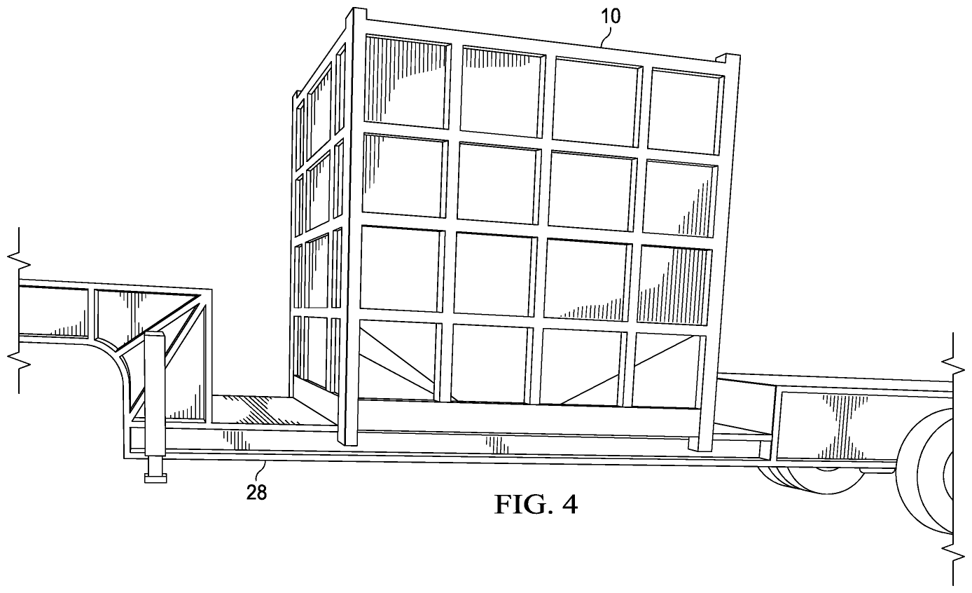

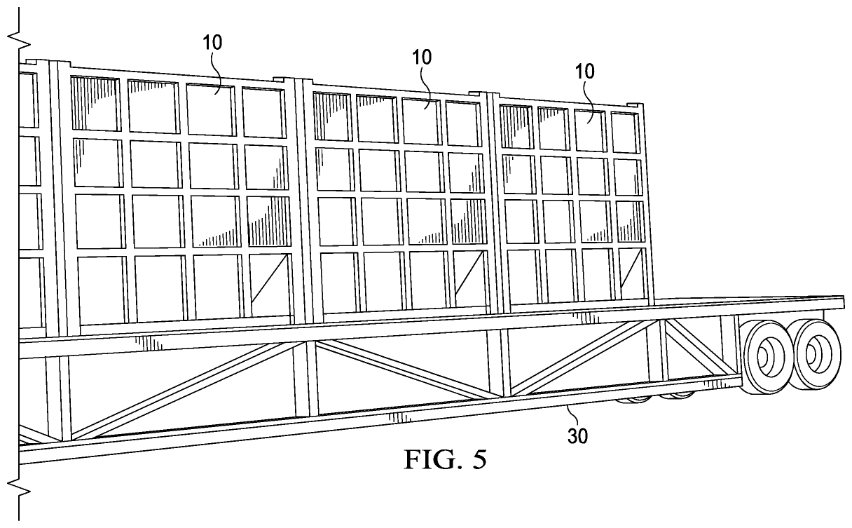

These vessels 10 are of a dimensional height to allow them to be transported on trailers 28, 30 in FIGS. 4 and 5 that comply with U.S. Department of Transportation regulations. For example, the sum of the dimensions of a vessel 10 or vessels 10 and the dimensions of a drop deck or flatbed trailer must be within or less than the federal motor vehicle legal dimension. In some embodiments, the vessels and trailers combined 10 may have a height of less than 13 feet 6 inches, a width of less than 8 feet 6 inches, and a weight of less than 45,000 pounds when fully loaded.

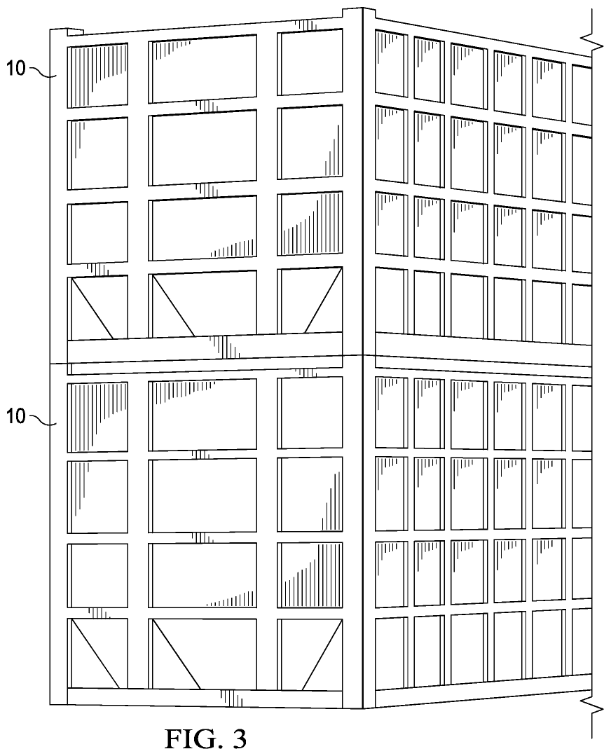

These vessels 10 may be constructed in such a way as to provide sufficient strength and structure to allow them to be transported and handled without damage to the vessel 10 or structure. The vessels 10 may include reinforced corners 32 of greater thickness than the sides of the vessel. In addition, the vessel 10 may include one or more ribs 34 at a position between each corner 32 or intersection of each side 26 with an adjacent side 26. In addition, this construction may be sufficient in strength to allow these vessels 10 to be stacked as illustrated in FIG. 3. They are constructed in such a way as to allow them to be interlocked, providing stability during stacking and transportation, as illustrated in FIGS. 3 and 5.

The vessels 10 may incorporate corner locks 36, such as corner locking pins (not illustrated) that are received in holes in the corner locks 36. The corner locks 36 may be universal locks similar to those used and provided on offshore containers. These corner locks 36 may be used to secure these vessels to a trailer during transportation on flat bed trailers and or rail cars. In other embodiments, any suitable locking mechanism may be used.

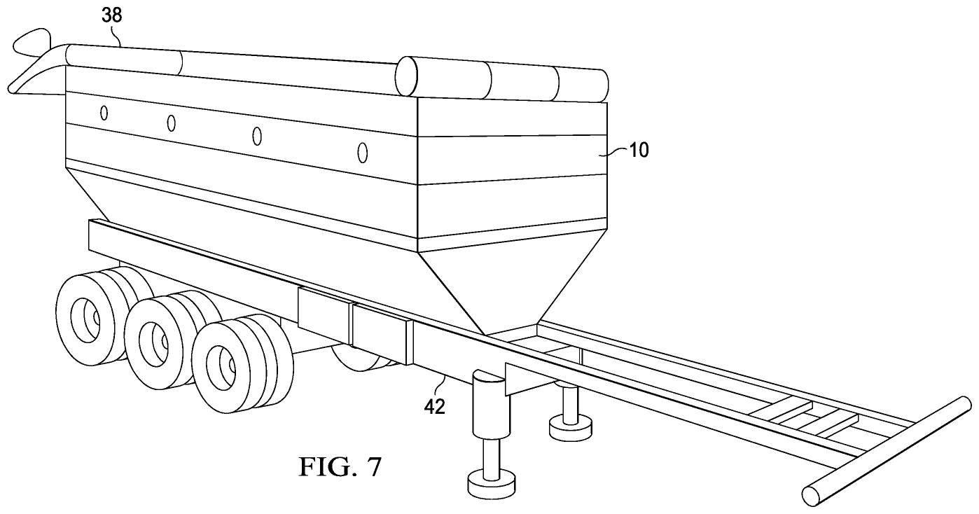

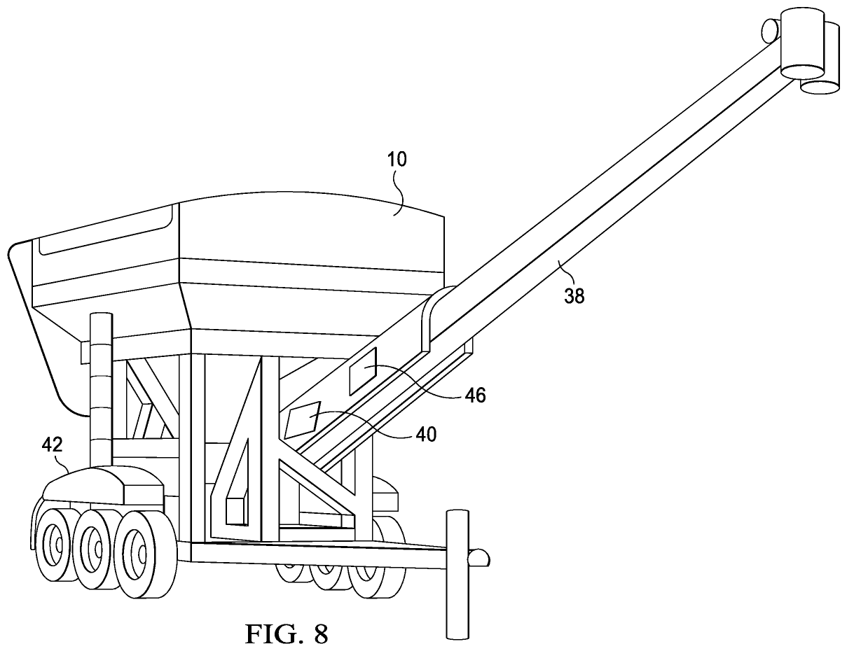

The vessels 10 may lock into or may be set onto a conveyor belt or auger system 38 (illustrated in FIGS. 7 through 9). This may allow the dry chemicals to be unloaded from the outlet 18 of the vessel 10. For purposes of the application and its claims, a conveyor is used to mean both a conveyor belt and an auger system (not illustrated).

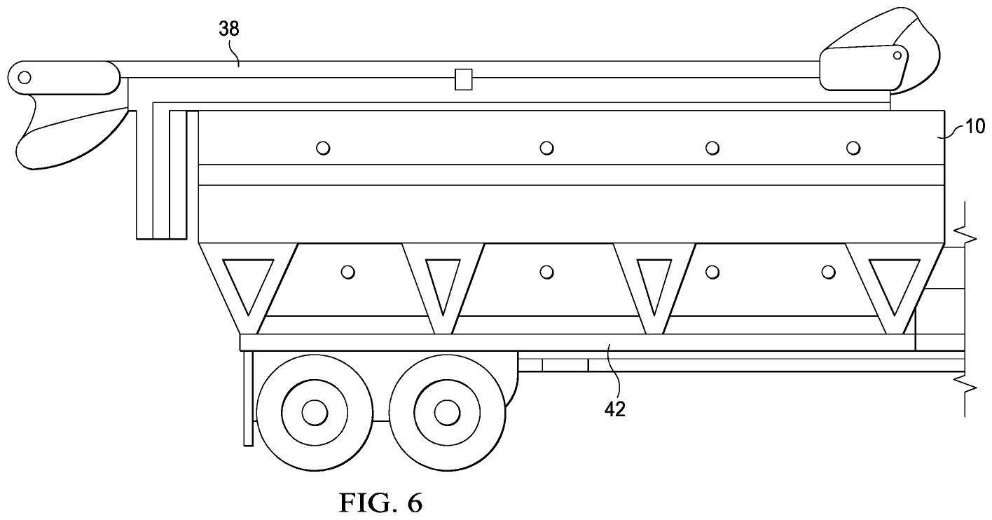

FIGS. 6 through 9 illustrate that the vessel 10 may be incorporated into a trailer 42 rather than standing alone. The trailer 42 may be of any type known. The trailer 42 optionally includes the conveyer 38 that is stowable and deployable from the trailer 42 so that it can be easily transportable and set-up on site. Alternatively, the conveyer 42 may be separate from the tank 10/trailer 42 arrangement and instead be used with the standalone vessels 10 illustrated in FIGS. 1 through 5.

The vessels 10 may be set on or may lock into a scale 40 that may be incorporated into the conveyor or auger 38 and unloader system. This scale 40 may be digital and/or mechanical and may be used to measure and record the weight of the chemical in each of the individual vessels. Information provided by the scale may then be used to meter and measure the introduction of the dry chemical into the fluid system. The scale 40 may be operatively and/or electrically coupled to a controller or processor so as to transmit a signal indicative of a weight of the vessel and/or the dry chemical in the vessel and to receive instructions from the controller or processor, and the controller may be used to send a signal to and/or control the opening of a valve or a slide gate 20 that may be incorporated into the bottom outlet 18 of each of the vessels 10. This may allow the vessels 10 to be opened and introduce material onto the auger or conveyor system 38 either sequentially or individually.

In embodiments, different types of dry chemicals may be stored in different vessels and may be simultaneously introduced onto the conveyor 38. The rate of introduction of each of the dry chemicals may be measured by the scales 40 and controlled by the slide gate or the valves 20 as they open or close the outlet 18. The slide gate and/or the valve 20 may be controlled with a controller/processor or operated manually by a user at the vessel 10.

The vessel or vessels 10 may be incorporated onto the conveyor or auger 38 in such a way as to provide a seal, such as with gaskets or flanges, between the vessel 10 and the conveyor or auger 38. This may prevent atmospheric conditions such as, but not limited to, rain, wind, snow, and humidity from affecting the dry chemicals. The seal between the vessel and the auger or conveyor may also prevent the release of dust from the dry chemicals as the dry chemicals are dispensed from the vessel and onto the auger or conveyor 38.

A desiccant filter may be incorporated onto a vent 44 of the vessel 10 to prevent moisture from entering into the vessel 10 and affecting the dry chemicals.

The vessels 10 may be sealed and a pressurized nitrogen gas cap may be disposed in the air gap above the chemical to prevent moisture from entering into the vessel 10 and affecting the dry chemical.

In one embodiment, a plurality of vessels 10 may be incorporated into the conveyor system 38 while additional vessels 10 may be stored on the application or well site. As the vessels 10 are emptied, one or more empty vessels 10 may be removed, such as with a forklift or other known method, from the conveyor 38 and one or more full vessels 10 may be placed on the conveyor. This process may be accomplished continuously.

One or more vibrators 46 may be incorporated on the conveyor or auger system 38. In addition, or alternatively, one or more vibrators 48 may be placed on the vessel 10, typically near the bottom 16, on the bottom, or one the bottom incline angle 14 of the vessel 10, although the vibrator 48 may be placed anywhere on the vessel 10 to aid the dry chemicals in flowing into the outlet 18 and onto the conveyor or auger 38.

The auger or conveyor 38 may be sealed as to prevent the material from getting wet as the material moves from the bottom of the vessel 10 to the application point. The auger or conveyor 38 may be sealed in any way one of ordinary skill in the art sees fit.

The dry chemicals may be dispensed, dumped, or poured directly into mixing tubs on the frac site and pumped into the wells via high pressure frac pumps as known in the art. In another embodiment, the auger or conveyor 38 may dump, dispense, or pour the chemicals into a shearing device 60, such as a sealed high-speed mixer, which may then be pumped from the high-speed mixer tub into the suction side of the high pressure frac pumps using centrifugal pumps. In other embodiments, any other suitable type of pump may be used.

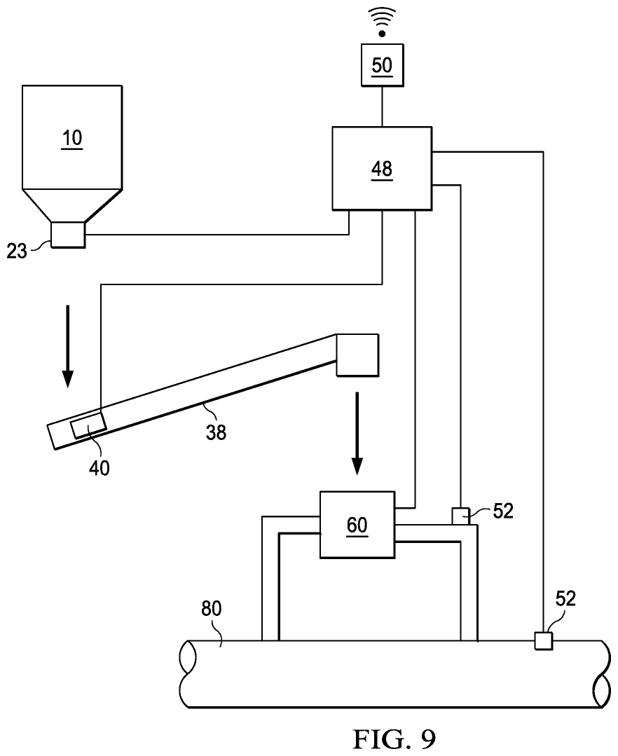

A controller or processor 48 may be used to interface with external instruments to measure and control the introduction of the dry chemicals into the fluid system as illustrated in FIG. 9.

A computer, controller, or processor 48 may be programmed with algorithms for one or more of time, rate, mass, mass flow, volume, volumetric flow, density, and other parameters and may be operatively coupled to the controller to control a rate at which the dry chemical is introduced into a fluid system. Any algorithm that programs one or more of time, rate, and other parameters may be used. The computer used may be located on site or off location with remote access to the controller.

A wireless transmitter 50 may be used to send a signal to the conveyor or auger 38 to control and to record the introduction of the dry chemical into a fluid system.

A flow meter 52 may be used to transmit a signal representative of the flow rate of the fluid in the main stream or pipe or the flow rate of the diverted fluid in the diversion pipe to the controller or processor 48. The controller or processor 48, in turn, may calculate the rate or volume of the dry chemical to be introduced into the frac fluid. A signal indicative of the rate or volume of the dry chemical to be introduced is then sent to an actuation mechanism 23 or controller that is operatively coupled to and operates a slide gate and/or valve 20 at the outlet 18 of the vessel 10, which allows for the introduction of the dry chemical.

The conveyer or auger system 38 may be incorporated onto a trailer 42 and may be transported to the application site where the auger or conveyor 38 may be positioned over the point at which the dry chemical is to be introduced into a fluid system. The vessels 10 may then be disposed on the conveyor and tied to the controller or processor 48.

The slide gate or gates or valve 20 on the vessel 10 may be controlled with and operated by one or more actuation devices 23, which may include mechanical devices, electro-mechanical devices, electrical devices, a pneumatic ram or rams, or hydraulic cylinders. Alternatively, the actuation device 23 may be part of the conveyor or auger system 38 and be coupled to the vessel 10 to operate the valve or slide gate 20. Optionally, the actuation device 23 may incorporate one or more proximity sensors 25 to determine the position of the slide gate or valve 20 and to control the amount or degree the actuation device 23 opens or closes the slide gate or valve 20.

A scraper or rotating rod 27 may be incorporated proximate the top 22 and/or the bottom 16 of each vessel 10 and extend toward the bottom or the top of the vessel, respectively. A low speed motor 29 that may be part of the conveyor or auger system 38 may then be attached to this rod or scraper 27. The rod 27 may be rotated to assist in the dry chemical flowing into the outlet 20. Without limitation, the motor 29 may be any suitable motor including electric, hydraulic, gas powered, solar powered, and the like.

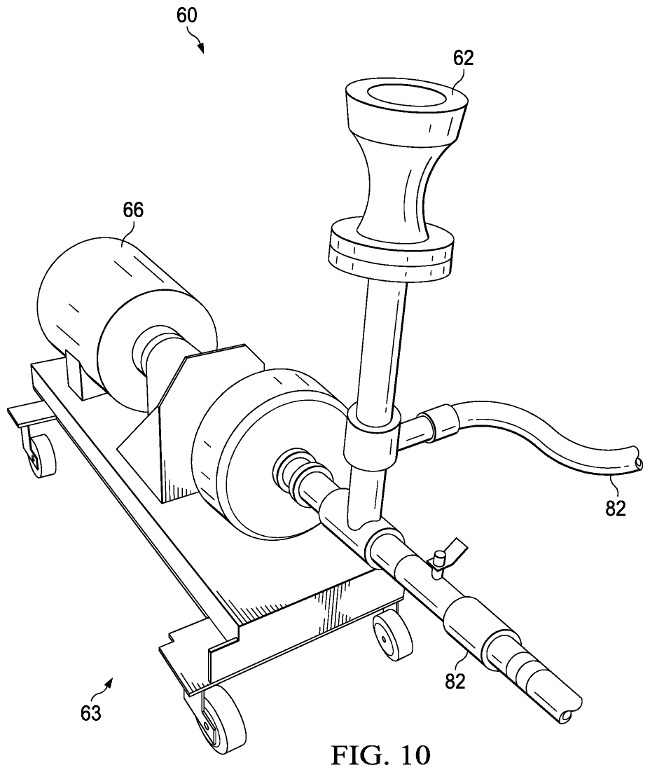

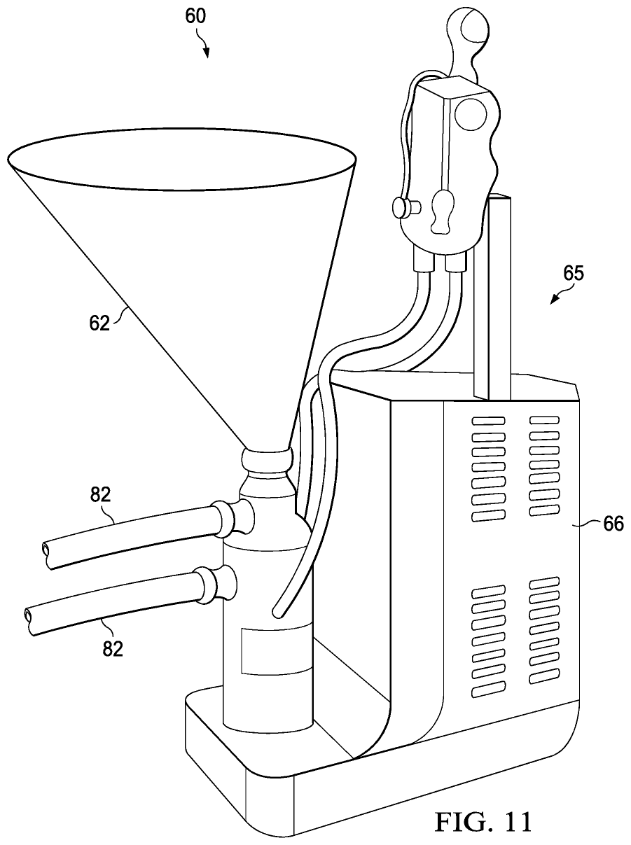

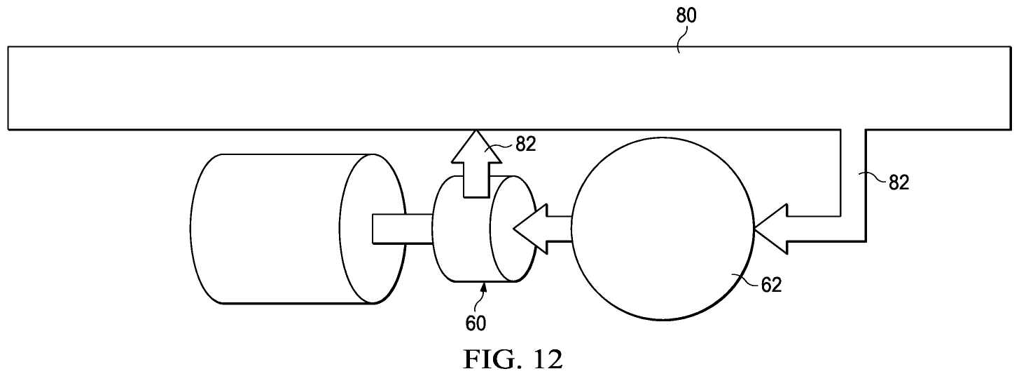

The dry material may be dispensed from the vessels 10 onto the auger or the conveyor system 38. A load cell or scale 40 may be used to determine the rate that the dry material may be removed from the vessels 10. The load cell 40 may calculate the rate at which the dry material is removed from the vessel 10 in mass per time unit, such as pounds per min. The dry material may then be introduced either directly from the vessel 10 into a hopper 62 or via the conveyor or auger 38 into the hopper 62. The hopper 62 may be fed to the suction side of a colloid mill 63 or a high-speed mixer 65, as illustrated in FIGS. 10 through 12.

A shearing device 60, such as a colloid mill 63 is a machine that may be used to reduce the particle size of a solid in suspension in a liquid, and/or reduce the droplet size of a liquid suspended in another liquid. The colloid mill 63 may comprise a rotor and/or a stator (not illustrated). The clearance between the rotor and stator of the colloid mill 63 may reduce the size of the dry material while mixing and rapidly hydrating the dry material directly into the water stream.

The colloid mill 63 may be coupled to a main water pipe 80, such as a suction manifold, that flows to the frac pumps. A smaller volume diversion pipe 82, or slip stream, may be pulled from main stream, such as via a suction header, through the colloid mill 63, and back into the main water pipe via the suction header. The dry chemical or material may be introduced into diverted water, i.e., the slip stream of water, on the suction side of the colloid mill 63. This mixture of the dry chemical and the diverted water may be a concentrated polymer-water mixture that may become diluted to the desired dosage ratios once it is introduced into the main water flow.

The raw, unground, dry materials, such as a chemical, for example a polymer, may be introduced into the shearing device 60, such as a high-speed mixer 65 or mill 62. The unground material may come into direct contact with water, a water-based solution, or another fluid-based (oil, synthetic oil, or another fluid) solution concurrently or subsequently as the unground material is introduced into the colloid mill 63 or high-speed mixer 65. As the colloid mill 63 or high-speed mixer 65 reduces a particle size of the unground material, the unground, partially ground, or wholly ground material may concurrently be wetted and dispersed into the fluid system, providing enhanced performance of the material by allowing more of the mass of the material to be exposed to the water or other fluid in the fluid system. It has been discovered in testing that this process may yield surprising and unexpected increase in the performance of the material by 20 percent, 50 percent, 75 percent, or at least or greater than 100 percent.

Optionally, the dry, unground material may be added to a colloid mill 63 or high speed-mixer 65. The unground material may come into direct contact with water, a water-based solution, or another fluid-based (oil, synthetic oil, or another fluid) solution concurrently or subsequently as the unground material is introduced into the colloid mill 63 or high-speed mixer 65, which may create a slurry that may have a high concentration of the material. The slurry may then be introduced into a larger volume of water, whereby the water is blended and diluted to make a final slurry. As a non-limiting example, it has been discovered in testing during a 10% slip stream, i.e., a volume of water diverted from a main stream of water in which the percentage diverted is calculated as a percentage of the flow of the main stream, was used to generate a concentrated slurry. The concentrated slurry was then reintroduced into the remaining 90 percent volume in the main stream, which may create a stream with a final concentration of the material that is less than the concentration of the material in the concentrated slurry. This process may be done in a moving body of fluid, the main stream and the diverted stream, without letting the material soak for a period of time (resonance time) before mixing with the main stream through the use of one or more batch mix containers.

The process of milling or mixing a material and concurrently or subsequently wetting the material and/or adding it directly to water surprisingly and unexpectedly yielded a significantly higher performance from the material and, in many instances, the highest performance of the material. Further, this process may eliminate a need to pre-grind the material or to introduce the material once ground into an oil suspension carrier, which is then introduced into water at the job site. This process consequently may save time, material costs (e.g., using only the material needed rather than any marginal or additional amount of material necessary to account for that portion of the material not successfully incorporated in the water or other fluid-based solutions as generated by previous processes), transportation costs, and storage costs, while providing improved levels of performance from the material.

Furthermore, in previous mixing processes we learned that in many of the materials comprising higher molecular weight, long strand polymers can become damaged because the previous mixing processes may generate too much shearing forces that are applied to the material after the material is fully wetted into the water or other fluid-based system.

In contrast, embodiments of the presently disclosed process in which the material may be introduced into the water as it is being mixed with a colloid mill 63 or a high-speed mixer 65, the material may tolerate significantly higher shear forces than previously acceptable. For example, there may be a short period of time, from a second, to tenths of seconds, hundreds of seconds, and even a few milliseconds during which a particle size of the material can be reduced by the colloid mill 63 or high-speed mixer 65, thereby exposing more of the material and more surface area of the material to the water, which, in turn, improves the performance of the material in the water without damaging the material, such as any long polymer strands.

### EXAMPLE

During recent testing a DISPAX Mixer, Model DR 2000/10 high-speed mixer 65 from IKA® Group of Staufen, Germany, was tested as a comparison to the colloid mill 63 and to the previously known batch-mixing methods.

The high-speed mixer 65 has 3 stages with multiple rows of teeth enabling higher amounts of shear energy to be put into a dry material, such as a polymer, as the raw, unground material was being introduced directly into a slip stream of water that represented 10 percent of the main flow.

More specifically, a main stream of water is provided, typically flowing through a main channel, pipe, tube, hose, or other conveyance. For purposes of the application the term main pipe 80 will apply to all structures capable of conveying a fluid. The volume flow rate of water of water flowing through the main pipe before any water is diverted is 100 percent.

A diversion channel, pipe, tube, hose, or other conveyance diverts a subset or portion of the main volume. For purposes of the application the term diversion pipe 82 will apply to all structures capable of conveying a fluid. The volume diverted is measured as a percentage of the undiverted volume. Thus, 10 percent diversion or 10 percent slipstream means that 10 percent of the main flow is diverted. For example, if the volume flow rate in the main stream is 1000 gallons/second, and 10 percent is diverted, then the flow rate in the diversion pipe 82 is 100 gallons/second.

Dry material or chemical, such as a polymer, may then be introduced into the flowing slipstream or water in the diversion pipe 82. For example, the dry material may be added as a percentage of either the water flowing in the diversion pipe or the main pipe, although it typically is calculated as a percentage of the main pipe. The dry material may be added as a percentage of either weight or volume.

For example, 1 percent material by weight or volume, was mixed with a high-speed mixer 65 and added to a 10 percent flow of water in the diversion pipe 82. The diverted water with the now mixed material was then introduced back into the remaining 90 percent water volume in the main pipe 80.

During the test the performance of the polymer and ultimate yield was improved by 70%, 80%, 90% and potentially greater than 100% as compared to introducing a dry ground polymer into the fluid and mixed via batch-mixing as in previous methods.

In this example, the dry material is the polymer 1405 high-viscosity friction reducer (1405 HVFR) provided by Coil Chem, LLC of Washington, Okla. It was applied at a dosage rate of 6 pounds of material per 1,000 gallons of water.

In the traditional batch-mixing of previous methods, the viscosity of the water in the main stream with the 1405 HVFR added was 24 centipoise (cp). It is suspected that when a polyacrylamide polymer, similar to the 1405 HVFR, is introduced into water under normal batch mixing and agitation, some of the polymer strands become encapsulated or entangled as they are hydrated. The encapsulated or entangled polymers thus are not available to be hydrated or otherwise functionally used in the main stream of water and, consequently, have no to minimal effect on the overall performance of the polymer in the main stream of water. Thus, to achieve a desired result, a greater than expected amount of polymer must be added to account for that portion that is “lost” or unavailable for use because of encapsulation or entanglement, leading to higher material, transportation, storage, and processing costs.

Although the “loss” of dry polymer to encapsulation or entanglement had been suspected, it was unknown just how much polymer and, consequently, how much performance otherwise imparted by the polymer, was lost. Further, once encapsulation or entanglement occurred, it was difficult to remedy because polyacrylamide polymer strands may be damaged if too much shear is put into the polymer after it has been hydrated. If the shear energy imparted to the hydrated or partially hydrated polymer is too great, the polymer strands may be damaged and, consequently, the ultimate viscosity of the water will be reduced. For this reason, it has been a long recognized and unmet challenge to impart enough shear energy into the polymer to allow the polymer strands to untangle and function after hydration without imparting too much shear energy as to cause damage to the strands that were not encapsulated or entangled in the first instance or had already become untangled.

By comparison, when the 1405 HVFR was ground with a colloid mill 63 and then added (either concurrently or subsequently) to the diverted water, which in turn was added to the main stream of water, the viscosity the main stream of the water with the 1405 HVFR was 33 centipoise, a 37.5% increase in performance.

By further comparison, when the 1405 HVFR was ground with the DISPAX Mixer, Model DR 2000/10 high-speed mixer 65 and then added (either concurrently or subsequently) to the diverted water, which in turn was added to the main stream of water, the viscosity of the main stream of the water with the 1405 HVFR was 45 centipoise, an 87% increase in performance compared to batch mixing.

Furthermore, when comparing the amp load on the motors 66 supplying the energy to the colloid mill 63 and the DISPAX Model DR 2000/10 high-speed mixer 65, it was discovered that the amp load on the DISPAX Model DR 2000/10 high-speed mixer 65 was 50 percent higher than the amp load on the colloid mill 63. It is believed that this increase in energy supplied to the DISPAX Model DR 2000/10 high-speed mixer 65 is directly correlated to the shear energy effectively applied to the 1405 HVFR without damaging or degrading the polymer and, in turn, directly correlated to the increase in the performance of the polymer.

As discussed above, high molecular weight polyacrylamide polymers similar to the 1405 HVFR typically were susceptible to damage to the polymer strand once hydrated and subjected to high shear energy. The Example demonstrates the unexpected and surprising result, however, that colloid mills 63 and high-speed mixers 65 may impart sufficiently high shear energy into the dry polymer without damaging the polymer strand if it is done over a short period of time, such as one second or less, tenths of seconds or less (e.g., 0.9-0.1 seconds), hundredths of seconds or less (e.g., 0.09-0.01 seconds), or thousandths of seconds or less (e.g., 0.009-0.001 seconds) or, more generally, quickly enough that the strands of the ground dry polymer can be separated without damage to the strand; the dry ground polymer is then simultaneously or subsequently introduced into the water and the separated polymer strands may be better exposed to the water.

TABLE 1

| | Polymer and | | |
|---|---|---|---|
| Process | Volume | Viscosity | Improvement |
| Batch-Mixing | 1405 HVFR at 6 | 24 centipoise | Not Applicable |
| (previous method) | pounds per 1,000 | | |
| | gallons of water | | |
| Colloid mill | 1405 HVFR at 6 | 33 centipoise | 37.5 percent |
| | pounds per 1,000 | | |
| | gallons of water | | |
| IKA DR 2000/10 | 1405 HVFR at 6 | 45 centipoise | 87 percent |
| high-speed mixer | pounds per 1,000 | | |
| | gallons of water | | |

It is believed grinding or processing the dry polymer with a shearing device 60, such as a colloid mill 63 or a high-speed mixer 65, before the polymer strands are added to water reduces the propensity of the dry polymer to become encapsulated or entangled during hydration as typically occurs in batch mixing. It is believed that this may the reason for the observed and substantial increase in the performance of the dry polymer when it is processed with a colloid mill 63 or high-speed mixer 65. For example, when using the DISPAX Model DR 2000/10 high-speed mixer 65 with 3 stages of high shear grinding surfaces, it is believed that the dry polymer was separated and divided before it was added to the water where it otherwise might become encapsulated or entangled and either lost to effective use or potentially damaged by any shear energy imparted to the water in an effort to disentangle the polymer.

With this understanding, a larger capacity system may be used to deliver the dry unground polymer into a colloid mill 63 or high-speed mixer 65 for processing and, in turn, directly into the water during frac and completion operations. Doing so may reduce, potentially significantly, the amount of material required during a hydraulic fracturing operation, reducing the cost and environmental impact of post-fracturing water cleanup. This system and method may also reduce the amount of material that is pumped into the well, which in turn may cause less damage to the porosity and the permeability of the reservoir and thereby possibly allow better production of any hydrocarbons from the well.

Methods of processing a material for use in a well site operation, which may be a chemical, a dry chemical, or a polymer, may include one or more of the following steps in any combination and any order: calculating a control signal for controlling an actuation mechanism to adjust the flow rate of the material out of an outlet of a vessel based on at least one of a time, the concentration of the material in the main stream of fluid, the concentration of the material in the diverted stream of fluid, the flow rate of the material, and a parameter of the main stream of fluid; dispensing the material into one of a main stream of a fluid and a diverted stream of a fluid; and, measuring and sending an indication to a processor of at least one of the flow rate of the material out of a vessel in which the material is stored, the flow rate of a main stream of fluid, the flow rate of a diverted stream of fluid, the concentration of the material in the main stream of fluid, and the concentration of the material in the diverted stream of fluid. The method may further include calculating a new control signal for controlling the actuation mechanism to adjust the flow rate of the material out of the outlet of the vessel based on at least one of the concentration of the material in the main stream of fluid, the concentration of the material in the diverted stream of fluid, the flow rate of the material, and the parameter of the main stream of fluid; and, operating the actuation mechanism to adjust the flow rate of the material. Optionally, method includes operating a shearing device that receives the material and/or disentangling a polymer included in the material and/or shearing the material shear the material prior to or concurrently with dispensing the material into one of the main stream of fluid and the diverted stream of fluid. The method may also include transferring the material dispensed from the vessel via the conveyor to the shearing device.

The one or more present inventions, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system for introducing material into a fluid at a well site, the system comprising:
a closed vessel that includes an inlet and an outlet for receiving and dispensing the material, respectively;
a valve configured to control a flow of the material out of the outlet;
a shearing device configured to receive the material from the closed vessel;
a main pipe configured to transmit a main stream of a fluid; and,
a diversion pipe configured to transmit a diverted stream of fluid,
wherein the diversion pipe is configured to transmit the diverted stream of fluid from the main pipe and return the diverted stream of fluid to the main pipe, and transmission of the diverted stream is driven by the main stream.

2. (canceled)

3. The system of claim 1, wherein the shearing device dispenses the material received from the closed vessel into one of the main stream of fluid and the diverted stream of fluid.

4. The system of claim 1, wherein the shearing device comprises one of a colloid mill and a high-speed mixer.

5. The system of claim 1, further comprising a conveyor device configured to transmit the material from the outlet of the vessel to the shearing device.

6. The system of claim 5, wherein the conveyor device is one of a conveyor belt or an auger.

7. The system of claim 1, wherein the material is at least one of a dry chemical and a polymer.

8. The system of claim 1, wherein the fluid includes water.

9. The system of claim 1, wherein the vessel includes at least one of a scraper or a rod.

10. The system of claim 1, further comprising:
a processor configured to implement computer executable instructions;
a first input interface in communication with the processor and configured to receive an indication of at least one of a flow rate of the material out of a vessel in which the material is stored, a flow rate of a main stream of fluid, a flow rate of a diverted stream of fluid, a concentration of the material in the main stream of fluid, and a concentration of the material in the diverted stream of fluid;
a first output interface in communication with the processor and configured to output a control signal for controlling an actuation mechanism coupled to an outlet of the vessel;
a computer memory in communication with the processor and storing computer executable instructions, that when implemented by the processor cause the processor to perform functions comprising:
calculate the control signal for controlling the actuation mechanism to adjust the flow rate of the material out of the outlet of the vessel based on at least one of a time, the concentration of the material in the main stream of fluid, the concentration of the material in the diverted stream of fluid, the flow rate of the material, and a parameter of the main stream of fluid;
dispense the material into one of the main stream of fluid and the diverted stream of fluid; and,
measure and send an indication to the processor of at least one of the flow rate of the material out of a vessel in which the material is stored, the flow rate of a main stream of fluid, the flow rate of a diverted stream of fluid, the concentration of the material in the main stream of fluid, and the concentration of the material in the diverted stream of fluid.

11. A control system for an apparatus that dispenses a material into a fluid, the control system comprising:
a processor configured to implement computer executable instructions;
a first input interface in communication with the processor and configured to receive an indication of at least one of a flow rate of the material out of a vessel in which the material is stored, a flow rate of a main stream of fluid, a flow rate of a diverted stream of fluid, a concentration of the material in the main stream of fluid, and a concentration of the material in the diverted stream of fluid;
a first output interface in communication with the processor and configured to output a control signal for controlling an actuation mechanism coupled to an outlet of the vessel;
a computer memory in communication with the processor and storing computer executable instructions, that when implemented by the processor cause the processor to perform functions comprising:
calculate the control signal for controlling the actuation mechanism to adjust the flow rate of the material out of the outlet of the vessel based on at least one of a time, the concentration of the material in the main stream of fluid, the concentration of the material in the diverted stream of fluid, the flow rate of the material, and a parameter of the main stream of fluid;
dispense the material into one of the main stream of fluid and the diverted stream of fluid; and,
measure and send an indication to the processor of at least one of the flow rate of the material out of a vessel in which the material is stored, the flow rate of a main stream of fluid, the flow rate of a diverted stream of fluid, the concentration of the material in the main stream of fluid, and the concentration of the material in the diverted stream of fluid;
wherein transmission of the diverted stream is driven by the main stream.

12. The control system of claim 11, wherein the functions further comprise:
calculate a new control signal for controlling the actuation mechanism to adjust the flow rate of the material out of the outlet of the vessel based on at least one of the concentration of the material in the main stream of fluid, the concentration of the material in the diverted stream of fluid, the flow rate of the material, and the parameter of the main stream of fluid; and,
operate the actuation mechanism to adjust the flow rate of the material.

13. The control system of claim 11, wherein the functions further comprise:
operate a shearing device that receives the material;
shear the material prior to or concurrently with dispensing the material into one of the main stream of fluid and the diverted stream of fluid.

14. The control system of claim 11, wherein the processor is located remotely from the vessel and communicates wirelessly with the actuation mechanism.

15. The control system of claim 11, wherein the parameter of the main stream of fluid is at least one of a viscosity and a density of the main stream of fluid.

16. The control system of claim 11, wherein the actuation mechanism is manually adjustable.

17. The control system of claim 11 further comprising a conveyor device coupled to the processor, wherein the function further comprises:
transfer the material dispensed from the vessel via the conveyor device to the shearing device.

18. The control system of claim 17 further comprising a scale coupled to the conveyor device, wherein the scale is in communication with the processor, wherein the function further comprises:
receive at the processor a signal indicative of a weight of the material as measured by the scale.

19. The control system of claim 11, further comprising a motor coupled to the shearing device, the motor being in communication with the processor.

20. The control system of claim 17, further comprising a motor coupled to the conveyor device, the motor being in communication with the processor.
